(19) United States
(12) Patent Application Publication
(10) Pub. No.: US 2002/0172292 A1
(43) Pub. Date: Nov. 21, 2002

(54) Error floor turbo codes

(76) Inventor: Paul K. Gray, Everard Park (AU)

Correspondence Address: Brian S. Edmonston, iCoding Tecnology, Inc., 11770 Bernardo Plaza Court, Suite 466, San Diego, CA, 92128, US

(21) Appl. No.: 09/849,742

(22) Filed: May 4, 2001

Related U.S. Application Data
(60) Provisional application No. 60/202,337, filed on May 5, 2000.

(51) Int. Cl. H04L 27/00

(52) U.S. Cl. 375/259

(57) ABSTRACT

A turbo code providing very low error rate performance and which can be practically implemented on an integrated circuit is described. In accordance with one embodiment of the invention a turbo code is comprised of three constituent codes and two interleavers placed in parallel concatenated configuration. In a first exemplary embodiment of the invention, the constituent codes are configured with at least one higher rate code and at least one lower rate code. In a second embodiment of the invention, the code is configured with one higher rate code and two lower rate codes. In a third embodiment of the invention, the code is comprised of at least one higher depth constituent code and at least one lower depth constituent code. In a fourth embodiment of the invention, the code is comprised of at least one higher rate and higher depth constituent code.

This application is a continuation in part of U.S. patent application Ser. No. 60/202,337 entitled “Improved Error Floor Turbo Codes” (client docket number P005) filed May 5, 2000.

### FIELD

The present invention relates to the area of forward error correction. More particularly, the present invention relates to coding and decoding schemes for performing very low error rate data forward error correction.

### BACKGROUND

Turbo coding a recently developed forward error correction coding and decoding technique that provides previously unavailable error correction performance. A general description of parallel turbo code can be found in U.S. Pat. No. 5,446,747 entitled “Error-correction Coding Method With at Least Two Systematic Convolution Codings in Parallel, Corresponding Iterative Decoding Method, Decoding Module and Decoder,” filed Apr. 16, 1992 assigned to France Telecom and incorporated herein by reference.

The enhanced level of error correction provided by turbo codes facilitates the transmission of data over noisy channels, thereby improving the data transmission capability of all sorts of communications systems. One characteristic of turbo codes that has limited their usefulness, however, is the presence of an “error floor,” or performance floor, after which the error correcting performance of turbo codes improves much more slowly than at lower signal to noise (SNR) ratios. This error floor reduces the usefulness of turbo codes in many communications applications that require very low error rates such as cable modems and satellite television broadcast.

The present invention is directed to providing very low error rate performance in a turbo code based forward error correction scheme.

### SUMMARY

A turbo code providing very low error rate performance and which can be practically implemented on an integrated circuit is described. In accordance with one embodiment of the invention a turbo code is comprised of three constituent codes and two interleavers placed in parallel concatenated configuration. In a first exemplary embodiment of the invention, the constituent codes are configured with at least one higher rate code and at least one lower rate code. In a second embodiment of the invention, the code is configured with one higher rate code and two lower rate codes. In a third embodiment of the invention, the code is comprised of at least one higher depth constituent code and at least one lower depth constituent code. In a fourth embodiment of the invention, the code is comprised of at least one higher rate and higher depth constituent code.

### DETAILED DESCRIPTION

An iterative forward error correction coding system is described. Various embodiments of the invention are described with reference to block diagrams. The blocks illustrate actual apparatus for hardware or steps performed in process. In one embodiment of the invention, the functions performed in each block are implemented using electronic devices such as integrated circuits that control current and voltage signals.

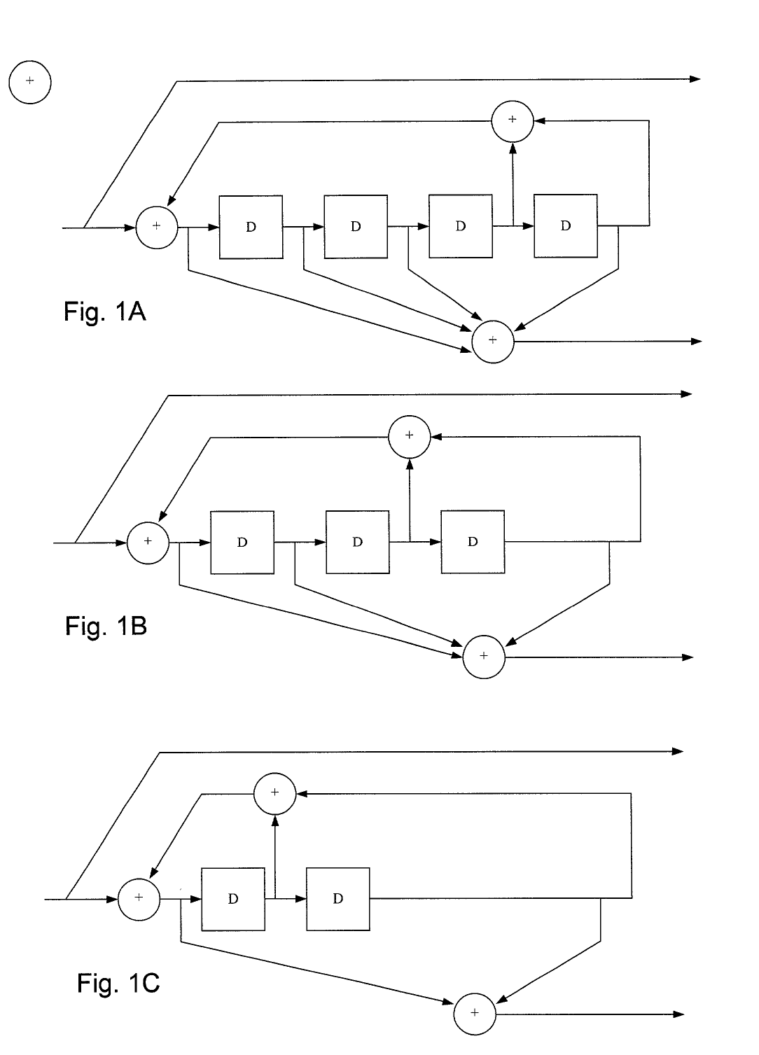

FIGS. 1A-D are diagrams of convolution encoders of different depth. configured in accordance with one embodiment of the invention. The convolutional encoders are recursive systematic convolutional (RSC) encoders, which are generally the preferred constituent encoder for use in a turbo code, however, other types of convolutional encoders may also be used.

FIG. 1A is an exemplary constraint length 5 (K=5) convolutional encoder, which is also referred to as a sixteen state code. The encoder is comprised of a set of memory elements D and a set of XOR gates labeled +. For purposes of this application the term depth is use to describe the number of memory elements (Labeled D) used for particular code, which is equal to K−1. As should be apparent, the number of state in a code corresponds to 2ˆ (K−1) or 2ˆ D. Throughout the application, constituent codes may be described in terms of constraint length (K), depth (D) or the number of states interchangeably.

FIG. 1B is an exemplary depth 3 (D=3) convolutional encoder, which is also referred to as an eight state code. FIG. 1C is an exemplary depth 2 (D=2) convolutional encoder, which is also referred to as a four state code. FIG. 1D is an exemplary depth 1 (D=1) convolutional encoder, which is also referred to as a two state code.

The various interconnects between the memory elements and XOR gates can be represented by “polynomials”, which uniquely define the code. While the polynomials shown provide superior performance to many other polynomials, alternative embodiments of the invention may use other polynomials that provide similar performance.

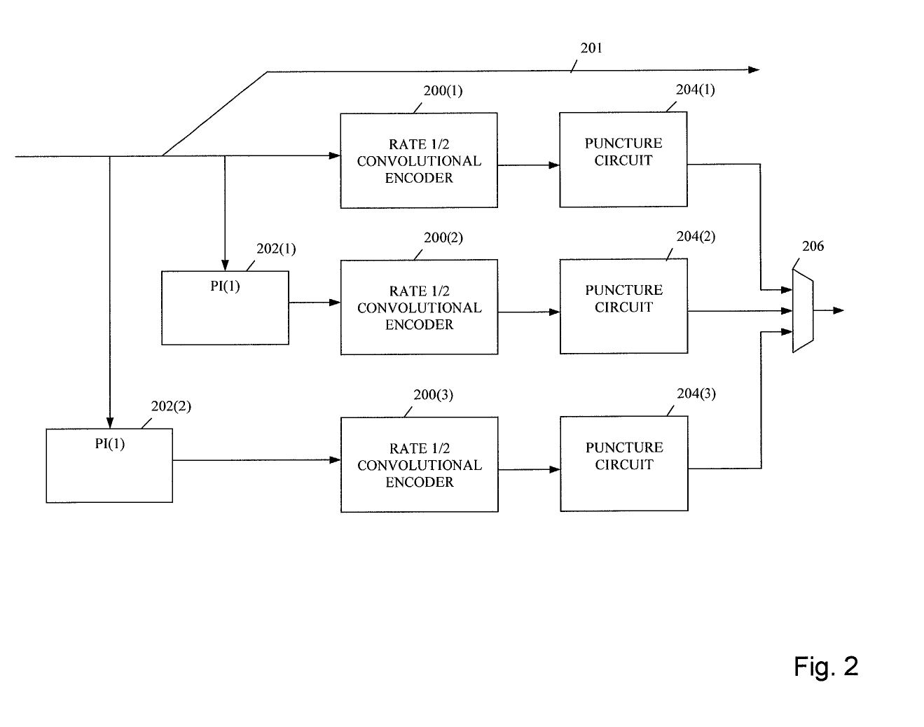

FIG. 2 is a block diagram of a turbo encoder configured in accordance with one embodiment of the invention. The encoder is comprised of three constituent encoders 200 and two interleavers 202. In the described embodiment, each constituent encoder is also accompanied by a puncture circuit 204. The outputs of the puncture circuits 204 are applied to multiplexer 206 which outputs the encoded symbols.

In this exemplary embodiment, encoders 200 are rate ½ encoders which are combined with puncture circuits 204 to yield encoders than can be programmed for a wide range of effective rates. The use of alternative base rates (other than rate ½) is consistent with use of the invention. Also, the use of codes having a “natural” (unpunctured) rate equal to the rate desired for a particular application is also well known, but typically provides less flexibility than the use of punctured codes.

An exemplary rate ⅔ encoding is described. During the exemplary encoding, data to be encoded is received by encoder 200(1) and interleavers 202(1) and 202(2). Encoder 200(1) performs rate ½ encoding and the resulting symbols are received by puncture circuit 204(1). Puncture circuit 204(1) removes three of every four parity symbols generated, yielding one parity bit for every four systematic bits transmitted. This yields an effective coding rate with respect to the systematic bits being transmitted of ⅘.

Interleaver 200(1) also receives the information bits and shuffles the bits according to a predetermined pattern yielding a first set of interleaved information bits. The predetermined pattern is preferably a pseudo random pattern and one example is described in greater detail below. Encoder 200(2) receives the first interleaved information bits and performs rate ½ encoding generating a parity bit for every information bit received. As with conventional two code turbo codes, the systematic bits from the second code are not used. Puncture circuit 204(2) removes 7 of every 8 parity bits received yielding an effective coding rate with respect to the systematic bits transmitted of 8/9.

Similarly, interleaver 200(1) also receives the information bits and shuffles the bits according to a second predetermined pattern yielding a second set of interleaved information bits. The predetermined pattern is preferably a pseudo random pattern and is described in greater detail below. Encoder 200(3) receives the second interleaved information bits and performs rate ½ encoding generating a parity bit for every information bit received. As with conventional two code turbo codes the systematic bits from this code are not used as well. Puncture circuit 204(3) removes 7 of every 8 parity bits received yielding an effective coding rate with respect to the systematic bits transmitted of 8/9.

The combination of the rate ⅘ constituent code and two rate 8/9 constituent codes yields an overall encoding rate of ⅔. Configuring the overall code to have one higher rate constituent code provides superior error correction over a code comprised of three equal rate constituent codes. In contrast, a rate ⅔ code having three equal rate constituent codes would be comprised of three rate 6/7 constituent codes.

Table I illustrates the puncture pattern used in the rate ⅔ exemplary embodiment of the invention.

TABLE I

| Symbol | Pattern |
|---|---|
| Systematic | ++++ ++++ ++++ ++++ |
| Parity Code 1 | +−−− +−−− +−−− +−−− |
| Parity Code 2 | −−+− −−−− −−+− −−−− |
| Parity Code 3 | −−−− −−+− −−−− −−+− |

In Table I, + stand for transmitting the symbol and − stands for puncturing the symbol. As is apparent, all the systematic bits from the first code are transmitted, as is typical practice for turbo codes, although not necessary. Additionally, the puncture rate for the first code is lower (fewer symbols are punctured) than for the second and third codes, making the effective coding rate for the first constituent code lower as well. That is, the parity symbols from constituent code one are transmitted at twice the rate of the parity symbols from constituent codes two and three.

The advantages of using one higher rate constituent codes are particularly significant for punctured codes, higher rate codes, and codes that use lower depth constituent codes. For example, where the overall code rate is greater that 0.6 (6/10), the performance difference resulting from the use of one higher rate constituent code is significant.

In many applications higher code rates are highly desirable because they allow greater information throughput. Additionally, the use of punctured codes is highly desirable as well due to the substantially increased flexibility they offer as well as significantly simplified implementation. Punctured codes are more flexible because a wide range of rates can be achieved by simply modifying the puncture pattern, causing little modification of the circuitry. Punctured codes are more easily implemented because they allow the same base code (Rate ½ in the example case) to be used for both constituent codes while not requiring the effective rate of the constituent codes to be the same, which facilitates hardware sharing both during encoding and decoding.

Additionally, the use of lower depth codes is also highly desirable because of the significant reduction in complexity. A depth 2 (D=2) code is half as complex as a depth 3 (D=3) code, and one forth as complex as a depth 4 (D=4) code. However, lower depth constituent codes typically degrade more with heavy puncturing. The amount of degradation experienced, however, is significantly reduced when the effective rate of at least one constituent code is kept high. Thus, the described embodiment allows lower depth constituent codes to be used in more highly punctured, higher rate, turbo codes.

For example, for the rate ⅔ turbo code, using the puncturing scheme described above with respect to Table I allows excellent decoding performance to be maintained using constituent codes with a depth no higher than 2 (D<=2). This performance is achieved by keeping the puncture rate for at least one constituent code fairly low. Thus, a powerful and fairly high rate code can be achieved using three constituent codes of depth no greater than 2. In contrast, a code that uses three equal rate codes experiences significant degradation when punctured to rate ⅔.

It should be noted that alternative embodiments of the invention may use higher depth constituent codes.

It should also be noted that using codes of such low depths in a conventional two constituent code based turbo code typically causes significant greater degradation in error correction performance. Thus, the overall complexity of a three constituent code turbo code may be less than for a two constituent code turbo code, since more complex constituent codes are required for the two constituent code turbo code.

The class of codes described also provides a lower error floor than the equivalent rate two constituent code based turbo codes or less optimized three constituent code based turbocodes, and therefore significantly increases the usefulness of turbocodes in a wide variety of applications which otherwise receive only minimal benefit from the incorporation of turbocoding technology.

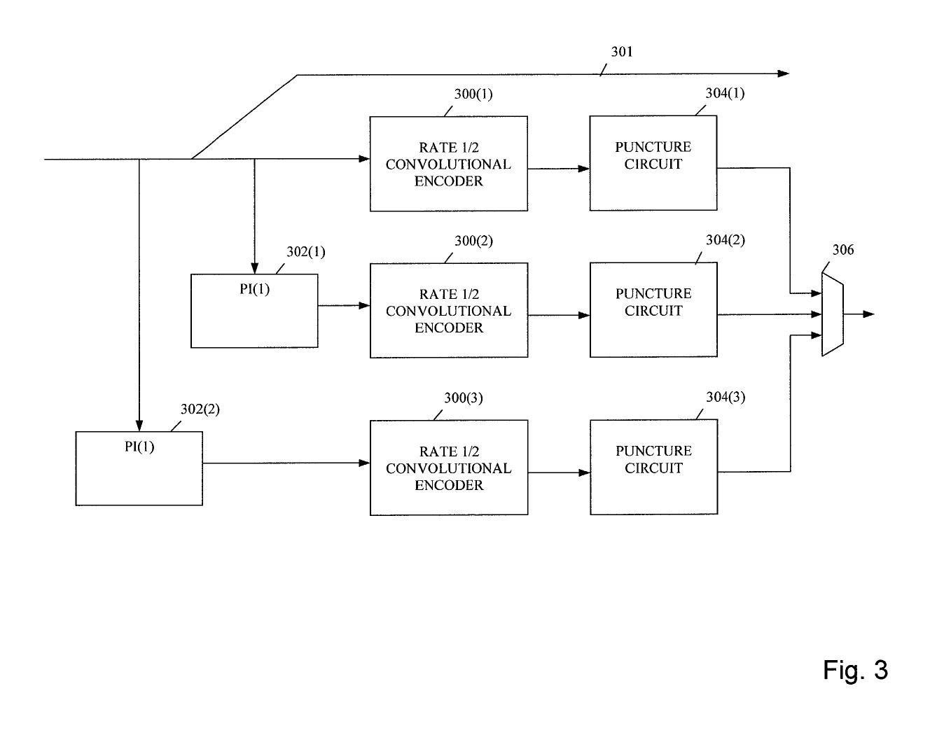

FIG. 3 is a block diagram of an encoder configured in accordance with a second embodiment of the invention. The encoder is comprised of three constituent encoders 300 and two interleavers 302. Each constituent encoder is also accompanied by a puncture circuit 304. The outputs of the puncture circuits 304 are applied to multiplexer 306 which outputs the encoded symbols in interlaced fashion.

Like the previous embodiment, constituent encoders 200 are rate ½ encoders that combine with puncture circuits 204 to yield encoders than can be programmed for a wide range of effective rates. Additionally, there are some differences in the depths of constituent encoders 303.

In particular, in a first exemplary embodiment described with reference to FIG. 3, constituent code 300(1) has a depth of D=4 for sixteen states. Constituent code 300(2) has a depth of D=3 for eight states and constituent code 300(3) has a depth of D=2 for four states. In one embodiment of the invention, the actual constituent codes selected correspond to the codes of FIG. 1. However, other constituent codes (polynomials) may also be employed.

In a first embodiment of the encoder shown in FIG. 3, the effective rate of the three constituent encoders 300 and associated puncture circuits 304 is equal. That is, each puncture circuit 304 punctures at the same rate yielding, three effectively equal rate constituent codes. For the rate ⅔ example, each puncture circuit 304 punctures 5 of every 6 parity bits yielding three constituent codes of effective rate 6/7. Table II illustrates the puncturing performed for three constituent codes of effective rate 6/7.

TABLE II

| Symbol | Pattern |
|---|---|
| Systematic | ++ ++ ++ |
| Parity Code 1 | +− −− −− |
| Parity Code 2 | −− +− −− |
| Parity Code 3 | −− −− +− |

While the turbo encoder having equal rate constituent codes described above with reference to FIG. 3 shows constituent code 300(1) to have the greatest depth, other embodiments of the invention may configure constituent code 300(2) or 300(3) to have the greatest depth.

In general, where the highest depth constituent code is greater than or equal to 4 (D>=4, sixteen state or greater) good performance has been experienced when both the other constituent codes are of lower depth than the highest depth constituent code. Additionally, even better performance has been experienced where the two other constituent codes are also of different depth as described above with respect to FIG. 2 (i.e. D=3 and D=2).

Alternatively, if the highest depth constituent code is less than or equal to 3 (D=3), good performance has been experienced when one of the other codes has a depth equal to the highest depth. For example, constituent encoders 300(1) and 300(3) have a depth D=3, while constituent encoder 300(2) has a depth D=2 or D=1.

Still referring to FIG. 3, in another alternative embodiment of the invention the effective rate of constituent encoders 300 and puncture circuits 304 are different for different codes. That is, amount of puncturing performed by one puncture circuit 304 is lower than for at least one other puncture circuit 304.

For example, a rate ⅔ code may be formed by a first code of effective rate ⅘ and two codes of effective rate 8/9 as described above with respect to FIG. 2. In this embodiment of the invention, the higher depth code should correspond to the code of lowest rate (the least punctured code). Thus, for the puncturing pattern of Table I applied to the code of FIG. 3, the constituent code 300(1) should be the highest depth. If two codes have depths equal to the highest value, the higher rate code should be one of those two constituent codes.

While the encoders of FIG. 2 and FIG. 3 show separate constituent encoders, interleavers and puncture circuits, alternative embodiments of the invention may use time shared circuits for one or more of these blocks.

To perform a spectrally efficient transmission, the exemplary rate ⅔ codes described herein may be combined with a 8PSK modulator configured in the well known Gray constellation. The two systematic bits are transmitted over the two most protected symbols in the symbol word, and the parity bit is transmitted over the third, least protected, symbol in the symbol word.

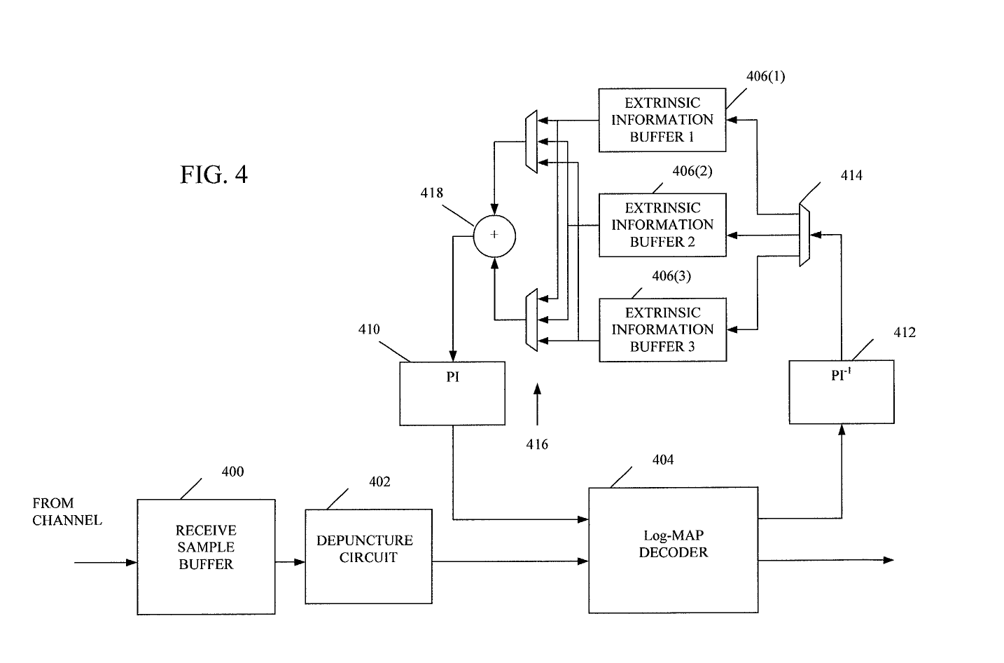

FIG. 4 is a block diagram of a turbo decoder configured in accordance with one embodiment of the invention. Depuncture circuit 402 is coupled to receive sample buffer 400 and log-MAP engine 404. Log-MAP engine 404 is coupled to extrinsic information buffer 406 via interleaver (PI) 410 and deinterleaver (PI⁻¹) 412, as well as multiplexers 414 and 416 and adder 418.

In one embodiment of the invention, depuncture circuit 402 can be configured by a control system (not shown, but typically a microprocessor controlled by software or a state machine) to depuncture for multiple puncture patterns. Additionally, log-MAP engine 404 can be configured to decode codes of differing depth, such as D=1, 2, 3 and 4. In a highly flexible embodiment of the invention, log-MAP engine 404 should also be able to decoding different polynomials for each given depth.

Log-MAP engine 404 is preferably implemented as a sliding window MAP decoder to reduce memory requirements. A description of a sliding window MAP decoder can be found in U.S. Pat. No. 5,933,462 incorporated herein by reference, as well as in co-pending U.S. patent application Ser. No. 60/202,344 entitled “METHOD AND APPARATUS FOR IMPROVED PERORMANCE SLIDING WINDOW DECODING” assigned to the assignee of the present invention and incorporated herein by reference. However, other embodiments of the invention may employ other MAP decoders, MAP decoder architectures, or soft-in-soft-out decoders.

During an exemplary decoding, receive samples that have been transmitted over the noisy channel are stored within receive sample buffer 400. Receive sample buffer is typically double buffered, whereby one full frame of receive samples are stored for decoding while another frame of receive samples is being received.

To decode, a series of decoding iteration and subiterations are performed. Each subiteration typically corresponds to one of the constituent codes used to encode the data. Each iteration typically corresponds to the set of constituent codes used to perform encoding. Thus, one iteration is typically comprised of a set of subiterations.

During the first subiteration, samples are retrieved from receive sample buffer 400 and depunctured by depuncture circuit 402. The depuncturing is performed according to the puncture pattern of the particular constituent code for which decoding is being performed. During depuncturing the parity bits from the other codes are skipped, and neutral values are inserted for the punctured bits.

Although not used for the first subiteration of the first iteration because no extrinsic information has been calculated, for the first subiteration of subsequent iterations, extrinsic information from extrinsic buffers 406(1) and 406(3) would be passed to sum circuit 418 via multiplexers 416. The summed extrinsic information is interleaved by intererleaver 410, which for this subiteration corresponds to the unity interleaver.

The resulting depunctured data stream (and extrinsic data for subsequent first subiterations) is fed to the log-MAP engine which performs rate ½ log-MAP decoding using a polynomial and depth of the corresponding constituent encoder. For the first subiteration of the first iteration this typically corresponds to constituent encoder 200(1) or 300(1). That is, the first decoding is typically performed for the constituent code that received the information bits in the same order as the transmitted bits, which typically corresponds to the constituent code that received non-interleaved information bits.

During the first decoding, log-MAP decoder generates extrinsic data that is passed through deinterleaver 412 to extrinsic information buffer 406(1). For the first subiteration, the interleaver is the typically the identity interleaver, which results in no effective reordering of the extrinsic information from log-MAP decoder 404.

During the next subiteration, depuncture circuit 402 retrieves the receive samples from sample buffer 400 and performs puncturing according to the puncture pattern for the second constituent code. The resulting depunctured information is fed to log-MAP decoder 406. Log-MAP decoder 406 also receives extrinsic information from extrinsic information buffers 406(1) and 406(3) after being summed by sum circuit 418 and interleaved by interleaver 410. For the first iteration, the extrinsic information in extrinsic information buffer 406(3) will be zero, as the third subiteration has not been performed.

During this second subiteration, interleaver 410 performs interleaving on the extrinsic information according to the interleaver that feeds the constituent code corresponding to the second subiteration. In an exemplary decoding of the codes of FIGS. 2 and 3 this would correspond to interleavers 200(1) or 300(1).

Log-MAP decoder 406 receives the receive samples and the interleaved extrinsic information and performs decoding according to the constituent code 202(2) or 302(2). The new extrinsic information is deinterleaved by deinterleaver 412 according to the interleaving done by interleaver 410 during this subiteration and stored via multiplexer 414 into extrinsic information buffer 406(2).

During the third subiteration, depuncture circuit 402 retrieves receive samples from receive sample buffer 400 and performs depuncturing according to the puncture pattern use for the corresponding constituent code. For the exemplary codes this corresponds to puncturing performed by puncture circuit 204(2) and 304(3).

The extrinsic information from extrinsic buffers 406(1) and 406(2) are then passed via mutiplexers 416 to sum circuit 418. The resulting summed extrinsic information is then interleaved to match the order of the depunctured receive samples from depuncture circuit 402. In accordance with the exemplary codes this corresponds to interleavers 202(2) and 302(2).

Log-MAP decoder receives the interleaved extrinsic information and depunctured receive samples and is configured to perform decoding according to the third constituent encoder. The resulting extrinsic information is deinterleaved by deinterleaver 412 according to the interleaver used for this subiteration and stored in extrinsic information buffer 406.

In the described embodiment, once a subiteration has been performed for each constituent code the iteration has been completed. Multiple iterations are then performed, with the extrinsic information slowly compensating for errors in the receive samples. Decoding is typically completed after a set number of iterations have been performed, or when checksum information indicates that the information has been decoded properly. During the last iteration or subiteration, log-MAP decoder produces hard decisions that are forwarded to the receiving system.

In the embodiment described above, a single MAP decoder that can be configured to process different depth codes is used. In an alternative embodiment of the invention, multiple log-MAP decoders each configured specifically for a particular constituent code may be employed. While this may increase the speed of each individual map decoder, greater circuit area will be required in order to implement the plurality of log-MAP decoders.

Similarly, while some embodiments of the invention uses a single rate ½ log-MAP decoder in combination with a depuncture circuit to achieve different coding rates, multiple map decoders each with unique natural rate may be used in alternative embodiments of the invention.

Also, while the above described embodiment uses a single depuncture circuit that can be configured for a variety of puncture patterns, an alternative embodiment of the invention may use multiple puncture circuits each configured for a particular puncture pattern.

Additionally, while a log-MAP decoder is preferred due to the higher processing speed and excellent decoding performance, other SISO decoders may be employed such as a multiplicative MAP decoder or SISO trellis decoder.

As described above, in accordance with the described invention at least two interleavers are used in the coding and decoding schemes. In accordance with one embodiment of the invention, both interleavers are s-type (spread) psuedo random interleavers. The s-type interleaver is based on the random generation of N integers from 0 to N−1 constrained to spread out the addresses. In particular, each randomly selected integer is compared to the S most recently selected integers. If the current selection is within S of at least one of the previous S integers, then it is rejected and a new integer is selected until the previous condition is satisfied.

While the use of s-type interleavers provides excellent performance, this types of interleaver requires the use of look-up tables operations to generate. Other interleavers that require look-up tables include dithered golden interleavers as described in Performance of Turbo-Codes with Relative Prime and Golden Interleaving Strategies, S. Crozier, J. Lodge, P. Guinand, and A Hunt, Communications Research Center, 3701 Carling Ave., PO Box 11490, Station H, Ottawa, Canada.

In accordance with another embodiment of the invention, a set of highly spread highly randomized generatable interleavers are used. Various method for generating such interleavers are described in co-pending U.S. patent application Ser. No. ______ entitled “High Spread Highly Randomized Generatable Interleavers” assigned to the assignee of the present invention and incorporated herein by reference (the “high spread” patent).

In one embodiment of the invention, at least one of the interleavers used in the code is a highly randomized generatable interleaver configured in accordance with the interleaver generation principals set forth in the high spread patent.

In another embodiment of the invention, both interleavers are highly randomized generatable interleavers configured in accordance with the interleaver generation principals set forth in the high spread patent. In this embodiment of the invention, some particularly good combinations exist.

In a first combination, two interleavers of size n*m, where m=2n are used. In accordance with the interleaver generation techniques set forth in the high spread patent, one interleaver is defined by a set of n seed values to which a value is repeatedly addeded to generate the remaining addresses and the interleaver is defined by a set of n seed values to which a value is repeatedly subtracted to generate the remaining addresses. Preferably each interleaver is also dithered as described in the high spread patent. Simulation has shown that this interleaver combination works well with a turbo code comprised of two 8 state codes and one 4 state code, although performance with many other codes is also very good.

In a second combination, one interleaver is comprised of an interleaver of size n*m where m is at least larger than m and preferably 2m. The interleaver is then constructed by adding (or subtracting) n to the set of seed values. The second interleaver is size n*m, where m is less than m, however. Thus the second interleaver will have a smaller spread and increased randomness with respect to the first interleaver. This combination of a highly spread less random interleaver with a more random less spread interleaver produces excellent results, particularly with may lower complexity code combinations.

For example, when combined with a very simple code comprised of all four state constituent codes, this interleaver combination can achieve bit error rates as low as 10e−10 for a rate ⅔ 8psk code for frame size of >10,000 bits. Achiving error rates this low using very simple constituent codes and generated interleavers provides a highly efficient and economical coding scheme that will allow the benefits of turbo coding to be incorporated into many applications.

Finally, in many embodiments of the invention it is preferable to tail bit one or more of the constituent codes. The use of tail biting is also described in the high spread interleaver patent. A description of tail biting can be found in the paper Weiβ, Ch.; Bettstetter, Ch.; Riedel, S.: Turbo Decoding with Tail-Biting Trellises. In: Proc. 1998 URSI International Symposium on Signals, Systems, and Electronics, 29. Sept.-2. Oct. 1998, Pisa, Italien, pp. 343-348.

To perform tail biting for encoders with feedback (which include the recursive systematic convolution codes described herein), the ending state x_{N} depends on the entire information vector u encoded. Thus, for a given input frame, the initial state x₀ must be calculated, where x₀ will lead to the same state after N cycles.

This is solved by using the state space representation:

xt+1=Axₜ+Bu_{T,t} (1)

vT,t=Cxₜ+Du_{T,t} (2)

Of the encoder. The complete solution of (1) is calculated by the superposition of the zero-input solution x[zi],t and the zero-state solution x[zs],t:

xt=x_{[zi],t}+x_{t,[zs]}=Aₜx₀+sum_{(j=0->t-1)}A^{(t-1)-j}Bu_{T,t.} (3)

By setting the state at time t=N equal to the initial state x₀, we obtain from (3) the equation

(A^{N}+Iₘ)x₀=x_{[zs],N} (4)

where Iₘ denotes the (m×m) identity matrix. If the matrix (Zₙ_{_{—}}Iₘ) is invertible, the correct initial state x₀ can be calculated knowing the zero state response x_{[zs],N}

Based on this logic, the encoding process should be done in two steps:

The first step is to determine the zero-state response x_{[zs],N} for a given information vector u. The encoder starts in the all-zero state x₀=0; all N k₀ information bits are input, and the output bits are ignored. After N cycles the encoder is in the state x_{[zs],N}. We can calculate the corresponding initial state x₀ using (4) and initialize the encoder accordingly.

The second state is the actual encoding. The encoder starts in the correct initial state x₀; the information vector u is input and a valid codeword v results.

In one embodiment of the invention the precomputed solutions to (4) for the desired frame size N (or sizes) can be stored in a look-up table.

Other emobidments of the invention can be described as follows:

1. A data transmission system for transmitting information bits comprising:

encoder for generating encoded symbols by encoding said information bits using at least three constituent encoders and two interleavers, wherein a first constituent encoder has a greater depth than a second constituent encoder;

decoder for decoding said encoded symbols by performing a series of subiterations using at least one soft-in-soft-out decoder for generating extrinsic data, wherein said subiterations are performed based on the depth of a corresponding constituent encoder, and said extrinsic data is interleaved during a portions of said subiterations based on said two interleavers.

2. An encoder for encoding information bits comprising:

first constituent encoder for generating a first set of parity symbols;

first interleaver for generating first interleaved information bits from said information bits;

second constituent encoder for generating a second set of party symbols from said first interleaved information bits;

second interleaver for generating second interleaved information bits from said information bits;

third constituent encoder for generating a third set of parity bits from said second interleaved information bits,

wherein at least one constituent encoder, selected from said first constituent encoder, said second constituent encoder and said third constituent encoder, has a greater depth than at least one other constituent encoder selected from said first constituent encoder, said second constituent encoder and said third constituent encoder.

3. An encoder for encoding information bits comprising:

first constituent encoder for generating a first set of parity symbols;

first interleaver for generating first interleaved information bits from said information bits;

second constituent encoder for generating a second set of party symbols from said first interleaved information bits;

second interleaver for generating second interleaved information bits from said information bits;

third constituent encoder for generating a third set of parity bits from said second interleaved information bits,

wherein at least one constituent encoder, selected from said first constituent encoder, said second constituent encoder and said third constituent encoder, has a rate greater than at least one other constituent encoder selected from said first constituent encoder, said second constituent encoder and said third constituent encoder.

4. An encoder for encoding information bits comprising:

at least three constituent encoders for generating sets of parity symbols based on said information bits, each constituent encoder having an encoding rate and encoding depth;

at least two interleavers for interleaving said information bits, wherein a first constituent code from said at least three constituent codes has a rate that is higher than a rate of at least one other constituent code from said at least three constituent codes, and wherein said first constituent code has a depth that is higher than at least one other constituent codes from said set of three codes.

5. An encoder for encoding information bits comprising:

first interleaver for generating first interleaved information bits from said information bits according to a first interleaver pattern;

second interleaver for generating second interleaved information bits from said information bits according to a second interleaver pattern;

first encoder for generating first parity bits from said information bits;

first puncture circuit for puncturing said first parity bits based on a first puncture pattern;

second encoder for generating second parity bits from said first interleaved information bits;

second puncture circuit for puncturing said second parity bits based on a second puncture pattern;

third encoder for generating third parity bits from said second interleaved information bits;

third puncture circuit for puncturing said first parity bits based on a first puncture pattern,

wherein one of said first encoder, said second encoder and said third encoder has a depth that is higher than at least one other encoder from said first encoder, said second encoder and said third encoder.

6. An encoder for encoding information bits comprising:

first interleaver for generating first interleaved information bits from said information bits according to a first interleaver pattern;

second interleaver for generating second interleaved information bits from said information bits according to a second interleaver pattern;

first encoder for generating first parity bits from said information bits;

first puncture circuit for puncturing said first parity bits based on a first puncture pattern;

second encoder for generating second parity bits from said first interleaved information bits;

second puncture circuit for puncturing said second parity bits based on a second puncture pattern;

third encoder for generating third parity bits from said second interleaved information bits;

third puncture circuit for puncturing said first parity bits based on a first puncture pattern,

wherein the puncture rate of one puncture pattern used by said first puncture circuit, said second puncture circuit and said third puncture circuit is lower than the puncture rate of at least one other puncture pattern used by said first puncture circuit, said second puncture circuit and said third puncture circuit.

7. The encoder of claim 6 wherein an encoder associated with said one puncture pattern has a depth that is higher than at least one other encoder selected from said first encoder, said second encoder and said third encoder.

8. An encoder for encoding information bits comprising:

first encoder for encoding said information bits, said first encoder having first depth;

second encoder for encoding said information bits, said second encoder having a second depth that is less than said first depth;

third encoder for encoding said information bits, said third encoder having a third depth that is less than said second depth.

9. The encoder of claim 8 wherein said first depth is greater than or equal to 4.

10. The encoder as set forth in claim 8 further comprising

first interleaver for interleaving said information bits according to a first pseudo random pattern;

second interleaver for interleaving said information bits according to a second pseudo random pattern.

11. The encoder as set forth in claim 10 wherein said information bits are transmitted in frames of size N, said first pseudo random pattern does not have two values of difference S within S members of each other, where S is greater than log2(N/4).

12. The encoder as set forth in claim 10 wherein said information bits are transmitted in frames of size N, said first pseudo random pattern does not have two values of difference S within S members of each other, where S is greater than log2(N/2).

13. An encoder for encoding information bits comprising:

first encoder for encoding said information bits, said first encoder having first rate;

second encoder for encoding said information bits, said second encoder having a second rate that is less than or equal to said first rate;

third encoder for encoding said information bits, said third encoder having a third rate that is less than said first rate.

14. The encoder of claim 13 wherein said rate is less than said first rate.

15. The encoder of claim 14 where said first encoder is comprised of:

base encoder for generating parity symbols;

puncture circuit for puncturing said parity symbols according to a puncture pattern.

16. The encoder of claim 14 wherein said first encoder is selected from a set of encoders including a natural encoder of said first rate, and a base encoder and puncture circuit configured for an effective rate equal to said first rate.

17. An encoder for encoding information bits comprising:

first interleaver for generating first interleaved information bits from said information bits according to a first pseudo random interleaver pattern;

second interleaver for generating second interleaved information bits from said information bits according to a second pseudo random interleaver pattern;

at least three constituent encoders each for generating parity bits from said information bits;

at least three puncture circuit corresponding to said constituent encoders, each for puncturing said parity bits according to corresponding puncture pattern;

wherein a first puncture rate of a first puncture circuit from said at least three puncture circuits is lower than a second puncture rate of a second puncture circuit from said at least three puncture circuits, and

wherein the depth of each encoder from said at least three encoders is less than or equal to 2.

18. The encoder of claim 17 wherein the depth of each encoder from said at least three encoders is equal to 2.

19. The encoder of claim 17 wherein a third puncture circuit from said set of puncture circuits has a third puncture rate equal to said second puncture rate.

20. The encoder of claim 17 wherein,

a second constituent encoder from said at least three constituent encoders, coupled to said second puncture circuit, receives first interleaved information bits from said first interleaver, and wherein

a third constituent encoder from said at least three constituent encoders receives second interleaved information bits from said second interleaver.

21. An encoder for encoding information bits comprising:

first convolutional encoder having a first depth;

second convolutional encoder having a second depth that is less than said first depth;

third convolutional encoder having a third depth, wherein said third depth is equal to said first depth.

22. The encoder as set forth in claim 21 wherein said first depth is 3 and said second depth is 2.

23. The encoder as set forth in claim 21 wherein said first depth is 3 and said second depth is 1.

24. The encoder as set forth in claim 21 where said first depth is 2 and said second depth is 1.

25. The encoder as set forth in claim 21 further comprising:

first pseudo random interleaver for interleaving said information bits according to a first pseudo random pattern;

second pseudo random interleaver for interleaving said information bits according to a second pseudo random pattern.

26. An encoder for encoding information bits comprising:

first convolutional encoder for generating first parity symbols from said information bits, said first convolutional encoder having a depth of 2;

first puncture circuit for puncturing said first parity symbols according to a first puncture pattern creating a first effective coding rate;

second convolutional encoder for generating second parity symbols from said information bits, said second convolutional encoder having a depth of 2;

second puncture circuit for puncturing said second parity symbols according to a second puncture pattern creating a second effective coding rate;

third convolutional encoder for generating third parity symbols from said information bits, said second convolutional encoder having a depth of 2;

third puncture circuit for puncturing said third parity symbols according to a third puncture pattern creating a third effective coding rate,

wherein said first effective coding rate is greater than said second effective coding rate and said third effective coding rate.

27. The encoder as set forth in claim 26 further comprising:

first pseudo random interleaver for interleaving said information bits according to a first pseudo random pattern;

second pseudo random interleaver for interleaving said information bits according to a second pseudo random pattern.

28. A method for encoding information bits comprising the steps of:

a) encoding a first ordering of said information bits according to a first convolutional code, said first convolutional code having a first depth;

b) encoding a second ordering of said information bits according to a second convolutional code, said second code having a second depth;

c) encoding a third ordering of said information bits according to a third convolutional code, said third convolutional code having a third depth, wherein

at least one depth from said first depth, said second depth and said third depth is not equal to at least one other depth from said first depth, said second depth and said third depth.

29. The method as set forth in claim 28 further comprising the steps of:

interleaving said information bits according to a first pseudo random pattern yielding said second ordering of said information bits;

interleaving said information bits according to a second pseudo random pattern yielding said third ordering of said information bits.

30. The method as set forth in claim 28 wherein,

said first depth is equal to said second depth; and

said third depth is lower than said first depth.

31. The method as set forth in claim 30 wherein, said first depth is equal to 3 and said third depth is equal 2.

32. The method as set forth in claim 30 wherein said first depth is equal to 3 and said third depth is equal to 1.

33. The method as set forth in claim 30 wherein said first depth is equal to 2 and said third depth is equal to 1.

34. The method as set forth in claim 29 wherein,

said first depth is equal to 4;

said second depth is equal to 3; and

said third depth is equal to less than 3.

35. A method for encoding information bits comprising the steps of:

a) encoding at a first effective rate a first ordering of said information bits according to a first convolutional code and first puncture pattern;

b) encoding at a second effective rate a second ordering of said information bits according to a second convolutional code and a second puncture rate;

c) encoding at a third rate a third ordering of said information bits according to a third convolutional code and a third puncture pattern, wherein

at least one effective rate from said first effective rate, said second effective rate and said third effective rate is not equal to at least one other effective rate from said first effective rate, said second effective rate and said third first effective rate.

36. The method as set forth in claim 35 further comprising the steps of:

interleaving said information bits according to a first pseudo random pattern yielding said second ordering of said information bits;

interleaving said information bits according to a second pseudo random pattern yielding said third ordering of said information bits.

37. The method as set forth in claim 35 wherein,

said second effective rate is equal to said third effective rate, and wherein said first effective rate is greater than said second effective rate.

38. The method as set forth in claim 37 wherein, said first effective rate is twice said second effective rate.

39. A method for encoding information bits comprising the steps of:

a) encoding at a first rate a first ordering of said information bits according to a first convolutional code;

b) encoding at a second rate a second ordering of said information bits according to a second convolutional code;

c) encoding at a third rate a third ordering of said information bits according to a third convolutional code, wherein

as least one rate from said first rate, said second rate and said third rate is not equal to at least one other rate from said first rate, said second rate and said third first rate.

40. The method as set forth in claim 39 further comprising the steps of:

interleaving said information bits according to a first pseudo random pattern yielding said second ordering of said information bits;

interleaving said information bits according to a second pseudo random pattern yielding said third ordering of said information bits.

41. The method as set forth in claim 40 wherein said first rate is greater than said second rate.

42. The method as set forth in claim 40 wherein said first rate is greater than said third rate.

43. The method as set forth in claim 40 wherein said first rate is greater than said second rate and said third rate.

44. A method for decoding an encoded signal comprising the steps of:

a) generating a set of receive samples from said signal;

b) decoding said receive samples according to a first coding scheme, wherein said first coding scheme has a first depth;

c) decoding said receive samples according to a second coding scheme, wherein said second coding scheme has a second depth;

d) decoding said receive samples according to a third coding scheme, wherein said third coding scheme has a third depth, and wherein at least one depth from said first depth, said second depth and said third depth is not equal to at least one other depth from said first depth, said second depth and said third depth.

45. The method as set forth in claim 45 wherein said first depth is equal to 4, said second depth is equal to 3 and said third depth is equal to 2.

46. The method as set forth in claim 45 wherein said first depth is equal to 3, said second depth is equal to 2, and said third depth is equal to 3.

47. The method as set forth in claim 45 wherein said first depth is equal to 3, said second depth is equal to 1, and said third depth is equal to 3.

48. The method as set forth in claim 45 wherein said first depth is equal to 2, said second depth is equal to 1, and said third depth is equal to 2.

49. The method as set forth in claims 45, 46, 47 or 48 further comprising the steps of:

deinterleaving said receive samples according to a first pseudo random pattern;

deinterleaving said receive samples according to a second pseudo random pattern.

50. A method for decoding an encoded signal comprising the steps of:

a) generating a set of receive samples from said signal;

b) decoding said receive samples according to a first coding scheme, wherein said first coding scheme has a first rate;

c) decoding said receive samples according to a second coding scheme, wherein said second coding scheme has a second rate;

d) decoding said receive samples according to a third coding scheme, wherein said third coding scheme has a third rate, and wherein at least one rate from said first rate, said second rate and said third rate is not equal to at least one other rate from said first rate, said second rate and said third rate.

51. The method as set forth in claim 50 wherein step b) is comprised of the steps of:

depuncturing said receive samples according to a first puncture pattern;

decoding said receive samples according to a first unpunctured code scheme.

52. The method as set forth in claim 50 wherein step b) is comprised of the step of decoding said receive samples according to a code with a natural rate equal to said first rate.

53. The method as set forth in claim 50 wherein said first rate is lower than said second and third rate.

54. The method as set forth in claim 50 or 53 wherein said first decoder has a higher depth that at least one other decoder selected from said second decoder and said third decoder.

55. The method as set forth in claim 50 or 53 wherein said first decoder has a first depth, said second decoder has a second depth, and said third decoder has a third depth, and wherein said first depth, said second depth and said third depth are less than or equal to 2.

56. The method as set forth in claim 55 wherein said first depth, said second depth, and said third depth are equal to 2.

57. The method as set forth in claims 50, 51, 52, 53, 54, 55, or 56 further comprising the steps of:

deinterleaving said receive samples according to a first pseudo random pattern;

deinterleaving said receive samples according to a second pseudo random pattern.

58. A method for transmitting information bits comprising the steps of:

a) encoding at a first effective rate a first ordering of said information bits according to a first convolutional code and first puncture pattern, yielding a first set of parity bits;

b) encoding at a second effective rate a second ordering of said information bits according to a second convolutional code and a second puncture rate, yielding a second set of parity bits;

c) encoding at a third rate a third ordering of said information bits according to a third convolutional code and a third puncture pattern, yielding a third set of parity bits;

d) transmitting said information bits, said first parity bits, said second parity bits and said third parity bits via a signal;

e) generating a set of receive samples from said signal;

f) decoding said receive samples according to said first coding scheme;

g) decoding said receive samples according to a second coding scheme;

h) decoding said receive samples according to a third coding scheme,

wherein at least one effective rate from said first effective rate, said second effective rate and said third effective rate is not equal to at least one other effective rate from said first effective rate, said second effective rate and said third first effective rate.

59. The method as set forth in claim 35 further comprising the steps of:

interleaving said information bits according to a first pseudo random pattern yielding said second ordering of said information bits;

interleaving said information bits according to a second pseudo random pattern yielding said third ordering of said information bits.

60. The method as set forth in claim 35 wherein,

said second effective rate is equal to said third effective rate, and wherein said first effective rate is greater than said second effective rate.

61. The method as set forth in claim 37 wherein, said first effective rate is twice said second effective rate.

62. A method for transmitting information bits comprising the steps of:

a) encoding at a first depth a first ordering of said information bits according to a first convolutional code and first puncture pattern, yielding a first set of parity bits;

b) encoding at a second depth a second ordering of said information bits according to a second convolutional code and a second puncture rate, yielding a second set of parity bits;

c) encoding at a third rate a third ordering of said information bits according to a third convolutional code and a third puncture pattern, yielding a third set of parity bits;

d) transmitting said information bits, said first parity bits, said second parity bits and said third parity bits via a signal;

e) generating a set of receive samples from said signal;

f) decoding said receive samples according to said first coding scheme;

g) decoding said receive samples according to a second coding scheme;

h) decoding said receive samples according to a third coding scheme,

wherein at least one depth from said first depth, said second depth and said third depth is not equal to at least one other depth from said first depth, said second depth and said third first depth.

63. The method as set forth in claim 62 wherein said first depth is equal to 4, said second depth is equal to 3 and said third depth is equal to 2.

64. The method as set forth in claim 62 wherein said first depth is equal to 3, said second depth is equal to 2, and said third depth is equal to 3.

65. The method as set forth in claim 62 wherein said first depth is equal to 3, said second depth is equal to 1, and said third depth is equal to 3.

66. The method as set forth in claim 62 wherein said first depth is equal to 2, said second depth is equal to 1, and said third depth is equal to 2.

67. The method as set forth in claims 62, 63, 64, 65 or 66 further comprising the steps of:

deinterleaving said receive samples according to a first pseudo random pattern;

deinterleaving said receive samples according to a second pseudo random pattern.

68. The method as set forth in claims 62, 63, 64, 65 or 66 further comprising the steps of:

generating a first initialization state by decoding an first end portion of said receive samples;

generating a second initialization state by decoding a second end portion of said receive samples, whereing

said first end portion comprises non-interleaved samples, and said second end portion comprises interleaved samples.

69. The method as set forth in claim 39 further comprising the steps of:

generating a first initialization state during the first encoding of said non-interleaved bits;

encoding said non-interleaved bits using said first initialization state.

70. The method as set forth in claim 39 further comprising the steps of:

generating a first initialization state during the first encoding of said interleaved bits;

encoding said interleaved bits using said first initialization state.

Thus, in forward error correction encoding and decoding scheme for providing very low bit error rate performance has been described. Various alternative embodiments will be apparent to those skilled in the art. The descriptions provided herein are only for purposes of example, and should not be viewed a limitations on the scope and character of the invention, which is set forth in the following claims:

1. A data transmission system for transmitting information bits comprising:
encoder for generating encoded symbols by encoding said information bits using at least three constituent encoders and two interleavers, wherein a first constituent encoder has a greater depth than a second constituent encoder;
decoder for decoding said encoded symbols by performing a series of subiterations using at least one soft-in-soft-out decoder for generating extrinsic data, wherein said subiterations are performed based on the depth of a corresponding constituent encoder, and said extrinsic data is interleaved during a portions of said subiterations based on said two interleavers.

2. An encoder for encoding information bits comprising:
first constituent encoder for generating a first set of parity symbols;
first interleaver for generating first interleaved information bits from said information bits;
second constituent encoder for generating a second set of party symbols from said first interleaved information bits;
second interleaver for generating second interleaved information bits from said information bits;
third constituent encoder for generating a third set of parity bits from said second interleaved information bits,
wherein at least one constituent encoder, selected from said first constituent encoder, said second constituent encoder and said third constituent encoder, has a greater depth than at least one other constituent encoder selected from said first constituent encoder, said second constituent encoder and said third constituent encoder.

3. A method for decoding an encoded signal comprising the steps of:
a) generating a set of receive samples from said signal;
b) decoding said receive samples according to a first coding scheme, wherein said first coding scheme has a first depth;
c) decoding said receive samples according to a second coding scheme, wherein said second coding scheme has a second depth;
d) decoding said receive samples according to a third coding scheme, wherein said third coding scheme has a third depth, and wherein at least one depth from said first depth, said second depth and said third depth is not equal to at least one other depth from said first depth, said second depth and said third depth.

4. The method as set forth in claim 3 wherein said first depth is equal to 4, said second depth is equal to 3 and said third depth is equal to 2.

5. The method as set forth in claim 3 wherein said first depth is equal to 3, said second depth is equal to 2, and said third depth is equal to 3.

6. The method as set forth in claim 3 wherein said first depth is equal to 3, said second depth is equal to 1, and said third depth is equal to 3.

7. The method as set forth in claim 3 wherein said first depth is equal to 2, said second depth is equal to 1, and said third depth is equal to 2.

8. The method as set forth in claim 3 further comprising the steps of:
deinterleaving said receive samples according to a first pseudo random pattern;
deinterleaving said receive samples according to a second pseudo random pattern.
